(19) United States
(12) Patent Application Publication
(10) Pub. No.: US 2009/0240514 A1
(43) Pub. Date: Sep. 24, 2009

(54) System and Method for Recommending a Bedding Product

(75) Inventors: Robert D. Oexman, Carthage, MO (US); Dave Scott, Carthage, MO (US)

Correspondence Address: SHOOK, HARDY & BACON LLP;INTELLECTUAL PROPERTY DEPARTMENT, 2555 GRAND BLVD, KANSAS CITY, MO, 64108-2613, US

(73) Assignee: L & P PROPERTY MANAGEMENT COMPANY, South Gate, CA (US)

(21) Appl. No.: 12/163,650

(22) Filed: Jun. 27, 2008

Related U.S. Application Data
(60) Provisional application No. 60/937,751, filed on Jun. 28, 2007.

(51) Int. Cl. G06Q 30/00; A47C 23/00; A47C 27/08; A47C 27/04; G01L 7/00

(52) U.S. Cl. 705/1; 5/254; 5/713; 702/50

(57) ABSTRACT

The present invention is directed at a system and method for recommending a bedding product for an individual. In one arrangement, a test mattress system comprises a mattress portion, a box spring portion, and fluid bladders positioned at various locations within the system. In an alternative embodiment, a method comprises the steps of taking a first pressure measurement of at least one bladder situated within a test mattress while the individual reclines on the test mattress; elevating pressure within the at least one bladder; and taking a second pressure measurement of the at least one bladder while the individual reclines on the test mattress.

### CROSS REFERENCE TO RELATED APPLICATIONS

This application claims the benefit of, and hereby incorporates by reference, commonly owned U.S. Provisional Patent Application No. 60/937,751 filed on or about Jun. 28, 2007.

### STATEMENT REGARDING FEDERALLY SPONSORED RESEARCH OR DEVELOPMENT

Not Applicable.

### INCORPORATION BY REFERENCE OF MATERIAL SUBMITTED ON A CD

Not Applicable

### BACKGROUND OF THE INVENTION

The present invention relates to the bedding industry and more specifically to a system and method for recommending a bedding product.

As bedding products become more advanced, customers have more component options from which to choose. For example, one can customize various components and features of a mattress and box springs. Certain component types and features, which provide various levels of support and cushion, are more appropriate for some types of customers than others. Component suitability depends on a variety of factors, such as body type, weight, flexibility, weight distribution, etc. As appropriate components can contribute to more restful sleep and proper support of various portions of a user's body, selecting components is an important determination. Unfortunately, it is often difficult for a customer to know which component attributes, such as level of firmness, will be most suitable for the customer. Various attempts have been made to assist customers with bedding product decision-making processes.

For example, U.S. Pat. No. 6,571,192 discloses an air mattress with sensors, which measures an individual's weight distribution and matches the individual to a suitable mattress system. However, among other things, the '192 patent fails to measure pressure changes at various portions of the mattress system and, therefore discloses a solution limited in the feedback that it can provide to an individual with respect to multiple mattress system components.

In addition, U.S. Pat. No. 5,148,706 discloses a mattress with sensors connected to springs of the mattress, which measure the pressure an individual exerts on the springs.

Additional limitations of the art include the failure to assess a customer's body flexibility.

### BRIEF SUMMARY OF THE INVENTION

There is now provided a new method and system for recommending a bedding product.

One objective of the present invention is assessing a customer's needs based on feedback provided at various portions of a bedding system. An additional objective of the present invention is assessing both weight distribution and body flexibility of a customer.

Systems and methods for recommending a mattress customized for a particular individual are provided. By having an individual position themselves upon a test mattress system, and measuring pressures at various locations within the test mattress system while one or more air bladders are filled to various relative air pressure values, the system determines how a mattress could be constructed to properly support the individual at various regions across the mattress. In embodiments, the systems and methods utilize a pressure profile for a particular individual to compare to a set of reference profiles in selecting a bedding product to recommend to the individual.

In one embodiment, the present invention comprises a method for recommending a bedding product for an individual. The method includes the steps of taking a first pressure measurement of at least one bladder situated within a test mattress system while the individual reclines on the test mattress system. The method then elevates pressure within the bladder and takes a second pressure measurement of the bladder while the individual reclines on the test mattress system. The first pressure measurement represents weight distribution of the individual, while the second pressure measurement represents the body flexibility of the individual.

In another embodiment, the present invention comprises a test mattress system for recommending a bedding product for an individual. The system includes a mattress portion having a support structure and a box spring portion situated beneath the mattress portion. A middle zone is located between the support structure and the box spring portion and has at least one fluid bladder located therein.

### BRIEF DESCRIPTION OF THE DRAWINGS

The present invention is described in detail below with reference to the attached drawing figures, wherein:

FIG. 1 is a side cross-section view of a system of the present invention; and

FIG. 2 is a flow chart of a method of the present invention.

### DETAILED DESCRIPTION OF THE INVENTION

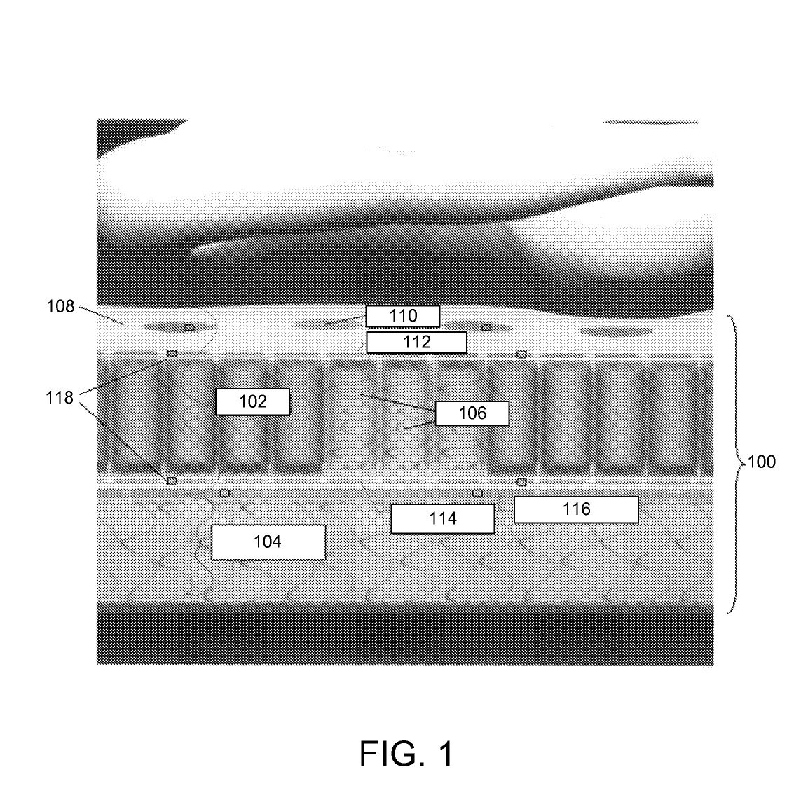

Referring now to FIG. 1, an embodiment of the present invention is shown, identified generally by numeral 100. In one embodiment, the present invention comprises a test mattress system 100 used for recommending a bedding product for an individual. The system 100 has a mattress portion 102, a box spring portion 104, and fluid bladders positioned at various locations within the system 100. The fluid bladders may be positioned within the mattress portion 102, within the box spring portion 104, between the mattress portion 102 and the box spring portion 104, and external to both the mattress portion 102 and the box spring portion 104.

One advantage of the present invention is the degree to which it simulates an actual mattress system, such as one a consumer would ultimately purchase for personal use. Accordingly, when the test mattress system 100 of the present invention takes measurements and provides feedback, the feedback is consistent with what a consumer would find in an actual mattress system.

For example, the mattress portion 102 is constructed with a support structure 106, and the box spring portion 104 is generally positioned beneath the mattress portion 102. The support structure 106 may comprise any component known by those of ordinary skill in the art to be used as such, and in one embodiment, the support structure 106 is a series of upright spring coils. Alternatively, the support structure may comprise a fluid medium, such as air, in one or more bladders or a combination of spring coils and fluid medium filled bladders. In addition, the mattress portion 102 may be constructed with a top cushioning material 108, positioned on top of the support structure 106. Accordingly, one or more zones exist within the system 100. One such zone is a middle zone located between the support structure 106 of the mattress portion 102 and the box spring portion 104. Other zones include an area directly above and overlaying the support structure, an area within the top cushioning material 108, an area directly below the support structure, and an area directly above and overlaying the box spring portion.

Fluid bladders 110, 112, 114, 116 of the present invention are designed to measure pressure and changes in pressure within the test mattress system, such as when an individual reclines on the system. In one embodiment, the fluid bladders 110, 112, 114, 116 are filled with air. Preferably, sensors 118 are coupled to the fluid bladders 110, 112, 114, 116, and the sensors 118 are configured to measure pressure within the fluid bladders 110, 112, 114, 116. One or more fluid bladders located within a zone are designed to measure pressure changes within that zone. For example, fluid bladders may be positioned within the top cushioning layer 108, on top of the support structure 106, underneath the support structure 106, on top of the box spring portion 104, or any combination thereof. A fluid bladder 110 positioned within the top cushioning layer 108 is designed to measure pressure changes within the top cushion layer 108. In embodiments of the present invention, the test mattress system comprises a layer of one or more primary fluid bladders 110 within the top cushioning layer 108, a layer of one or more top support structure fluid bladders 112 on top of the support structure 106, a layer of one or more bottom support structure fluid bladders 114 underneath the support structure 106, and a layer of one or more top box spring fluid bladders 116 on top of the box spring portion 104. Embodiments of the present invention comprise a layer of one or more fluid bladders positioned within at least one or more of the aforesaid listed positions, i.e. within the top cushioning layer 108, on top of the support structure 106, underneath the support structure 106, or on top of the box spring portion 104. Fluid bladders may be positioned within any combination of the aforesaid listed positions. Fluid bladders may also be positioned within all of the aforesaid listed positions.

In embodiments of the present invention, laterally-spaced, parallel, interconnected channels (not shown) may be constructed to connect bladders within a same layer. Said channels provide evenly distributed support across the layer by evenly distributing fluid within the bladders. Furthermore, each fluid bladder layer may be connected by channels (not shown) to one or more other fluid bladder layers to provide pressure equalization across all fluid bladder layers of the system. In a further arrangement, the system of the present invention comprises a device for increasing and decreasing the pressure of the one or more fluid bladders 110, 112, 114, 116.

An array of sensors 118 are coupled to each layer of one or more fluid bladders 110, 112, 114, 116. In one arrangement, sensors 118 are distributed throughout each layer of one or more fluid bladders 110, 112, 114, 116 in a horizontal x-y grid. The sensors 118 function to measure pressure changes within the one or more fluid bladder layers 110, 112, 114, 116. For example, changes in pressure may occur when an individual reclines on the mattress. Changes in pressure may also occur when fluid is either put into, or released from, fluid bladders. Further, sensors 118 function to measure pressure changes at positions of the system, the positions corresponding to where various parts of the individual's body would be resting, the parts including, but not limited to, head, neck, shoulders, mid-section, waist, hips, and feet.

Preferably, output from sensors 118 are coupled to a processor (e.g., a microprocessor and memory, or an application-specific integrated circuit) for computing pressure values based on the sensor output. The processor is also coupled to a storage device (e.g., a computer hard drive, or other removable or non-removable storage means) for storing the pressure values of each sensor, and is further connected with a database of reference values that correlate with a particular reference cushioning profile.

A reference cushioning profile functions as a guide against which pressure values resulting from a reclining individual may be compared to determine a proper bedding product for the individual. Reference cushioning profiles may be developed by recording relevant characteristics of a test group of individuals for storage in a database. Relevant characteristics of a test individual include, but are not limited to, body type (e.g. height, weight, waist size, shoulder size, etc.); pressure exerted by the test individual on the system's one or more fluid bladder layers 110, 112, 114, 116 when the fluid bladder layers are filled to a first pressure; pressure exerted by the test individual on the system's one or more fluid bladder layers 110, 112, 114, 116 when the fluid bladder layers are filled to a second pressure, the second pressure elevated relative to the first pressure; and a proper bedding product for the test individual based on the individual's weight distribution and flexibility. Pressure values for each individual in a test group may be obtained at varying bladder air pressure values in order to measure both weight distribution and body flexibility for the individuals, ensuring that the reference cushioning profiles developed are reflective of support distribution across the mattress.

Methods of the present invention comprise steps for recommending a bedding product to an individual and utilize a test mattress system 100 of the present invention. Accordingly, any embodiment of the test mattress system disclosed, expressly or inherently, herein may be used in the methods of the present invention. In one embodiment, a method comprises the steps of taking a first pressure measurement of at least one bladder situated within the test mattress system 100 while the individual reclines on the test mattress system 100; elevating pressure within the at least one bladder; and taking a second pressure measurement of the at least one bladder while the individual reclines on the test mattress system 100.

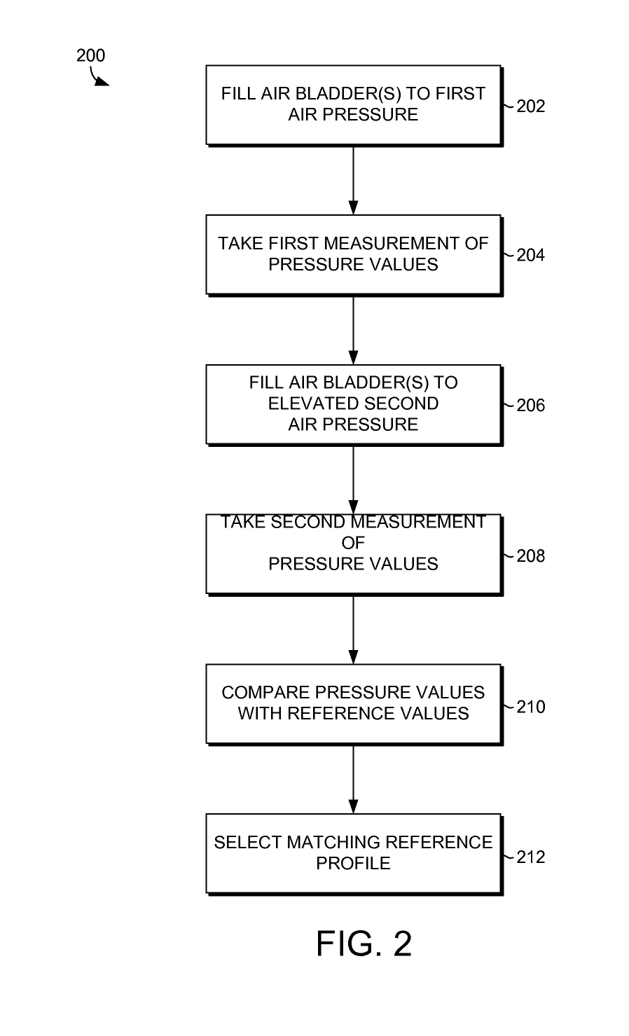

One method of the present invention is illustrated in FIG. 2 and is generally identified by the numeral 200. According to the method 200, one or more fluid bladders is filled to a first air pressure, at step 202. For example, one or more of fluid bladder layers 110, 112, 114, 116 may be filled to a first air pressure. In one embodiment of the method 200, the first air pressure comprises ambient air pressure. If the test mattress system 100 is constructed so that the bladder layers 110, 112, 114, 116 are interconnected with one another, then pressure equalization between the layers occurs automatically. Alternatively, in a separate step (not shown), each bladder layer 110, 112, 114, 116 may be separately filled with air to the first air pressure. A user then reclines upon the test mattress system 100 (i.e., directly on the cushioning layer 108) during which sensors 118 take a first measurement of pressure values, at step 204. This step enables the system 100 to develop a weight distribution profile for the individual. At step 206, one or more fluid bladders are filled to a second air pressure, the second air pressure being elevated relative to the first air pressure. For example, one or more of the bladder layers 110, 112, 114, 116 may be filled to the second air pressure. In one embodiment, all bladders within a layer are filled to a second air pressure. In an alternative embodiment, only selected bladders within a layer are filled to a second air pressure. For example, selected bladders may comprise bladders only in the user's lumbar region. Then, at step 208, sensors 118 take a second measurement of the pressure values while the individual is reclining on the test mattress system. Taking the pressure measurement values at air pressures in excess of the first air pressure enables the system 100 to develop a body flexibility, or firmness, profile for the individual. In one instance, lumbar flexibility is determined by measuring pressure changes at bladders corresponding to the lumbar region of a user. Where only selected bladders are filled to a second air pressure, a user with less flexibility may exert more pressure on the selected bladders, and a user with more flexibility may exert less pressure on the selected bladders. At step 210, the first measurement of the fluid bladders at the first air pressure and the second measurement of the fluid bladders at an elevated air pressure are compared with reference cushioning values. In other words, the measured weight distribution profile and body flexibility profile are compared to reference profiles. Based on the results of the comparison, the closest reference profile correlation for the first and second measurements is selected to be the matching reference profile, at step 212. Ideally, the matching reference profile is representative of the bedding product that provides the particular individual with a high level of cushioning and support beneath all areas of the individual's body.

From the foregoing, it will be seen that this invention is one well adapted to attain all the ends and objects hereinabove set forth together with other advantages which are obvious and which are inherent to the structure.

It will be understood that certain features and subcombinations are of utility and may be employed without reference to other features and subcombinations. This is contemplated by and is within the scope of the claims.

Since many possible embodiments may be made of the invention without departing from the scope thereof, it is to be understood that all matter herein set forth or shown in the accompanying drawings is to be interpreted as illustrative and not in a limiting sense.

We claim:

1. A method for recommending a bedding product for an individual, the method comprising the steps of:
(a) taking a first pressure measurement of at least one bladder situated within a test mattress system while the individual reclines on the test mattress system;
(b) elevating pressure within the at least one bladder; and
(c) taking a second pressure measurement of the at least one bladder while the individual reclines on the test mattress system.

2. A method for recommending a bedding product for an individual using a test mattress system comprising at least one bladder with at least one sensor, the method comprising the steps of:
(a) before the individual reclines on the test mattress system, filling the at least one bladder to a first pressure value;
(b) while the individual is reclining on the test mattress system with the at least one bladder filled to a first pressure value, taking a first measurement with the at least one pressure sensor of pressure within the bladder;
(c) filling the at least one bladder to a second pressure value, the second pressure value comprising a value elevated relative to the first pressure value;
(d) while the individual is reclining on the test mattress system with a bladder filled to a second pressure value, taking a second measurement with the at least one pressure sensor of pressure within the bladder;
(f) correlating the first measurement and the second measurement to a reference profile; and
(g) based on the correlation, identifying a bedding product for the individual.

3. The method of claim 2 wherein the test mattress system comprises:
(a) a mattress portion comprising a support structure and a top cushioning layer;
(b) a box spring portion situated beneath the mattress portion;
(c) at least one zone, wherein a middle zone is located between the support structure and the box spring portion; and
(d) fluid bladders, wherein at least one fluid bladder is located in the middle zone.

4. The method of claim 3 wherein the test mattress system comprises:
(a) at least one bladder integrated into the top cushioning material;
(b) at least one bladder overlaying the support structure;
(c) at least one bladder underlying the support structure; and
(d) at least one bladder overlaying the box spring portion.

5. The method of claim 2 wherein the first pressure value is equal to ambient air pressure.

6. The method of claim 2 further comprising using the first measurement to develop a weight distribution profile of the individual.

7. The method of claim 2 further comprising using the second measurement to develop a body flexibility profile of the individual.

8. The method of claim 2 wherein the reference profile is established by:
(a) filling the bladders to a first profile pressure value;
(b) measuring sensor readings at the first profile pressure value for a test group of individuals, the test group comprising individuals of various body types;
(c) filling the bladder to a second profile pressure value;
(d) measuring sensor readings at the second profile pressure value for the test group of individuals; and
(e) based on the sensor readings for each test group individual, determining an appropriate bedding product.

9. A test mattress system for recommending a bedding product for an individual, the system comprising:
(a) a mattress portion, comprising a support structure;
(b) a box spring portion situated beneath the mattress portion;
(c) at least one zone, wherein a middle zone is located between the support structure and the box spring portion; and
(d) fluid bladders, wherein at least one fluid bladder is located in the middle zone.

10. The system of claim 9,
wherein the mattress portion comprises a top cushioning material positioned on top of the support structure;
wherein one or more pressure sensors are coupled to at least one bladder;
wherein the one or more pressure sensors are coupled to a processor for computing pressure values; and
wherein the processor is coupled to a storage device for storing pressure values and a database of reference values.

11. The system of claim 10 wherein at least one bladder is integrated into the top cushioning material.

12. The system of claim 10 wherein at least one bladder overlays the support structure.

13. The system of claim 10 wherein at least one bladder underlies the support structure.

14. The system of claim 10 wherein at least one bladder overlays the box spring portion.

15. The system of claim 10 wherein the pressure sensors are distributed throughout a bladder layer in a horizontal x-y grid.

16. The system of claim 10 wherein the reference values correlate with a reference bedding product profile.

17. The system of claim 9 wherein the support structure comprises upright spring coils.

18. The system of claim 9 wherein fluid bladders comprise interconnecting channels to provide evenly distributed support.
